(19) United States
(12) Patent Application Publication
(10) Pub. No.: US 2009/0071087 A1
(43) Pub. Date: Mar. 19, 2009

(54) GARAGE DOOR VENT WITH SCREEN

(76) Inventor: John J. Achen, Yuma, AZ (US)

Correspondence Address: C. ROBERT VON HELLENS;CAHILL, VON HELLENS & GLAZER P.L.C., 155 PARK ONE,, 2141 E. HIGHLAND AVENUE, PHOENIX, AZ, 85016, US

(21) Appl. No.: 12/054,218

(22) Filed: Mar. 24, 2008

Related U.S. Application Data
(60) Provisional application No. 60/910,372, filed on Apr. 5, 2007.

(51) Int. Cl. E04B 1/70; E04B 1/92; E06B 7/08

(52) U.S. Cl. 52/302.1; 52/741.3; 52/473; 52/747.1

(57) ABSTRACT

A louvered vent assembly having a spline retained insect screen is mounted in a garage door between interior and exterior frames to provide ventilation and prevent intrusion of insects.

### CROSS REFERENCE TO RELATED APPLICATIONS

The present application is related to and claims priority to a provisional application entitled “Garage Door Vent With Screen” filed Apr. 5, 2007 and assigned Ser. No. 60/910,372 disclosing an invention made by the present inventor.

### BACKGROUND OF THE INVENTION

1. Field of the Invention

The present invention relates to garage door vents and, more particularly, to garage door vents adapted for use with insect screens and mounted in a panel of a garage door.

2. Description of Related Prior Art

During the summertime in the southwest United States and in climatologically similar areas, the temperature in an unvented enclosed garage increases to well over 100 EF. Such a high temperature may cause damage or deterioration to temperature sensitive items stored or otherwise disposed within such a garage. Moreover, the high temperatures render it very uncomfortable for a person working within the garage. To alleviate this problem, it is not uncommon to install vents in one or more exterior walls of the garage to permit airflow into and out of the garage.

The simplest of such vents is a louvered panel of relatively light weight material nailed or screwed to the exterior surface of a wall in juxtaposed relationship with a corresponding aperture. Such louvered panels permit the intrusion of insects through the louvers.

Many automatic garage doors have a plurality of longitudinal panels with adjacent panels being hingedly attached to one another to permit the garage door to be raised and lowered along opposed tracks. These tracks include a 90E bend at the upper edge of the garage opening which necessitates the hinged panels to accommodate the bend of the tracks. To permit air flow into and out of the garage, one or more louvered panels may be mounted in the garage door panels. These louvered panels permit air flow therethrough. Unfortunately, the louvered panels also permit intrusion of insects and possibly small varmints.

### SUMMARY OF THE INVENTION

A vent for a garage door includes an interior open frame mountable on the interior side of a panel of the door and around an opening therein. A groove is disposed in the frame encircling the opening. A section of plastic mesh or screen extends across the frame and into the groove. The screen is secured in the groove of the frame with a spline forced into the groove on top of the adjacent section of screen. A louvered panel extends across the frame and adjacent the groove to prevent dislodgment of the spline from within the groove. The interior frame and its attachments may be secured in place with an exterior frame disposed on the exterior panel of the of the garage door and interconnected with screws. In another embodiment, the groove and spline are located in the louvered panel. In a further embodiment the louvered panel and extension frame are formed as a unit continuing the groove and spline. The interior frame leans against the spline in the groove to return it in place.

It is therefore a primary object of the present invention to provide a labor saving easy to install air vent and insect screen in a garage door.

Another object of the present invention is to provide a screened air vent for a garage door which is retained by a frame external to the garage door.

Still another object of the present invention is to provide a vent for a garage door having an insect screen retained by a spline adjacent the interior surface of an exterior louvered panel.

Yet another object of the present invention is to provide a screened air vent in sealed engagement with a panel of a garage door.

Yet another object of the present invention is to provide structure for easily attaching and retaining in place a screen in a louvered vent.

A further object of the present invention is to provide a screened air vent for a garage door having an easily attached screen.

A still further object of the present invention is to provide a method for installing a screened air vent in a garage door.

A yet further object of the present invention is to provide a method for assembling a screen in a screened air vent for a garage door.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 is an isometric view of a conventional multi-paneled garage door incorporating the present invention;

FIG. 2 is an isometric view of the louvered vent shown in the garage door in FIG. 1;

FIG. 3 is an isometric rear view of the vent shown in FIG. 2 and mounted in a panel of the garage door;

FIG. 4 is an exploded isometric view of the major components of the present invention;

FIG. 4A is a cross-sectional view taken along lines 4A-4A, as shown in FIG. 4;

FIG. 5 is an exploded side view of the components of the present invention;

FIG. 6 is a partial cross-sectional view illustrating attachment of the interior frame with the exterior frame of the vent;

FIG. 6A is a partial cross-sectional view illustrating the groove and spline for retaining an insect screen;

FIG. 7 illustrates the insect screen attached to the interior frame;

FIG. 8 illustrates the construction of a variant vent for a garage door panel;

FIG. 8A is a partial view taken along lines 8A-8A, as shown in FIG. 8;

FIG. 9 is a rear view of the vent partly shown in FIG. 8;

FIG. 10 is an exploded isometric view of the variant vent;

FIG. 11 illustrates a partial cross section of a further variant vent;

FIG. 12 is a partial cross sectional view illustrating the details of the further variant vent and taken along lines 12-12, as shown in FIG. 11;

FIG. 13 is a rear view of the further variant vent;

FIG. 14 is a partial view illustrating elements for insulating and weather proofing the vent;

FIG. 15 is a partial view illustrating attachment of retaining straps;

FIG. 16 is a partial view illustrating attachment of retaining straps and an impermeable plate; and

FIG. 17 is an isometric rear view illustrating attachment of the straps.

### DESCRIPTION OF THE PREFERRED EMBODIMENT

Referring to FIG. 1, there is shown a conventional multi-paneled garage door 10 having panels 12, 14, 16 and 18 hingedly attached to one another. The door is raised and lowered along tracks disposed interior of wall 20 defining opening 22 to the garage. In the event of malfunction of the conventional electric motor used to raise and lower garage door 10, a handle 24 is secured to a panel, such as panel 14. To permit airflow into and out of the garage, one or more louvered vents 30 may be disposed in one or more of the panels of the garage door. To permit airflow by convection, one or more louvered vents 30 may be disposed in an upper panel and one or more louvered vents may be disposed in a lower garage door panel.

Referring to FIG. 2, there is shown a vent 30. This vent includes an exterior frame 32 (see also FIG. 1) adjacent the exterior surface of a louvered panel 34 and secured to a garage door panel, such as panel 18.

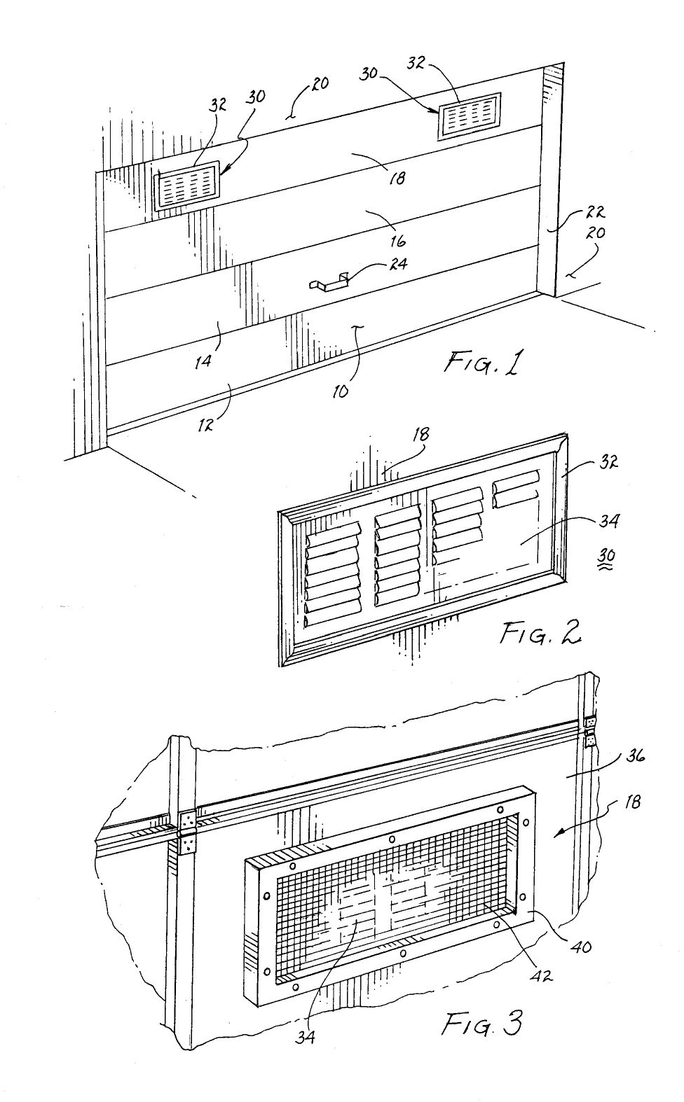

An interior frame 40 of vent 30 supports an insect screen 42, as shown in FIG. 3. As partly visible through the screen, louvered panel 34 is disposed on the other side of the insect screen. Interior frame 40 is disposed adjacent interior surface 36 of one of the garage door panels, such as panel 18 illustrated in FIGS. 1 and 2.

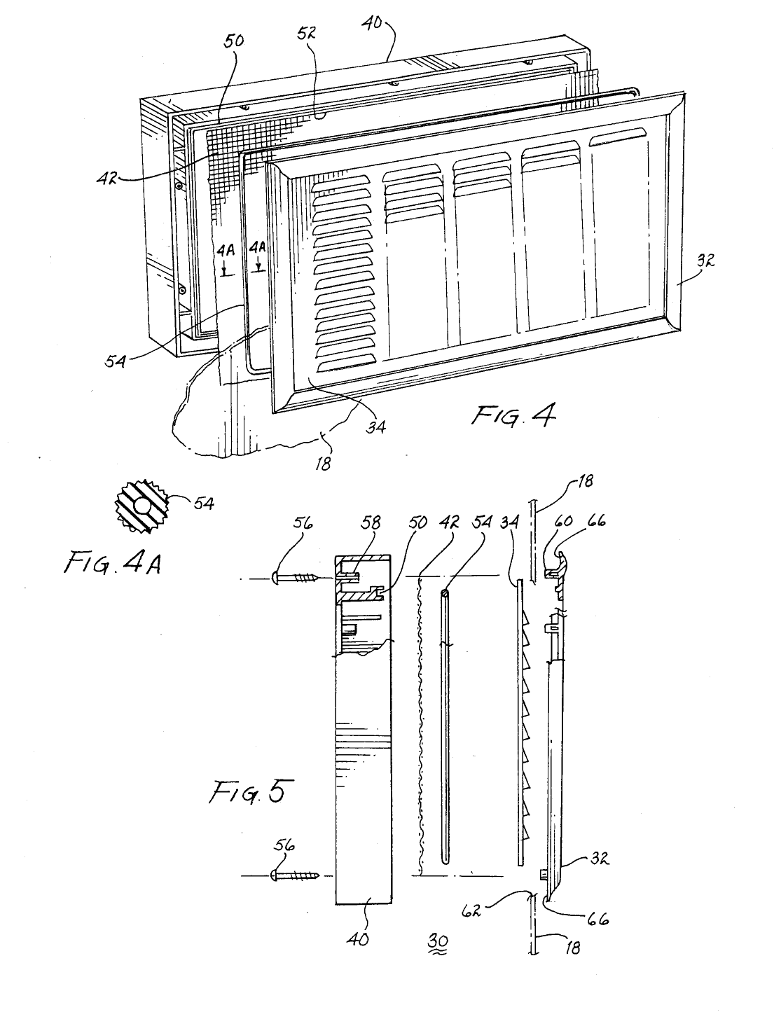

Referring to FIGS. 4 and 4A, there is illustrated an exploded view of the various components that make up vent 30. Louvered panel 34 is disposed adjacent the back side of exterior frame 32. Interior frame 40 includes a groove 50 extending about opening 52 in the interior frame. An insect screen 42 extends across opening 52 and across groove 50. To retain the insect screen in place, a length of a spline 54 of the type commercially available is forced adjacent insect screen 42 and into groove 50. Dislodgement of the spline from within the groove is precluded by louvered panel 34 being placed against and extending across the groove upon assembly of interior frame 40 with exterior frame 32. As illustrated in part, panel 18 of a garage door is disposed interior of exterior frame 32.

Referring to FIG. 5, there is shown an exploded side view of the basic components illustrated and described in FIGS. 4 and 4A. In FIG. 5 there is also shown screws 56 extending through bosses 58 in interior frame 40 into threaded engagement with bosses 60 extending interiorly from exterior frame 32. Thereby, the interior frame is secured to exterior frame 32 and screen 42, spline 54 and louvered vent 34 are retained in an immobile state intermediate the exterior and interior frames. It is to be noted that garage door panel 18 includes an opening 62 sufficient to accommodate airflow through the louvered panel and to provide a bearing surface for peripheral edge 66 of exterior frame 32.

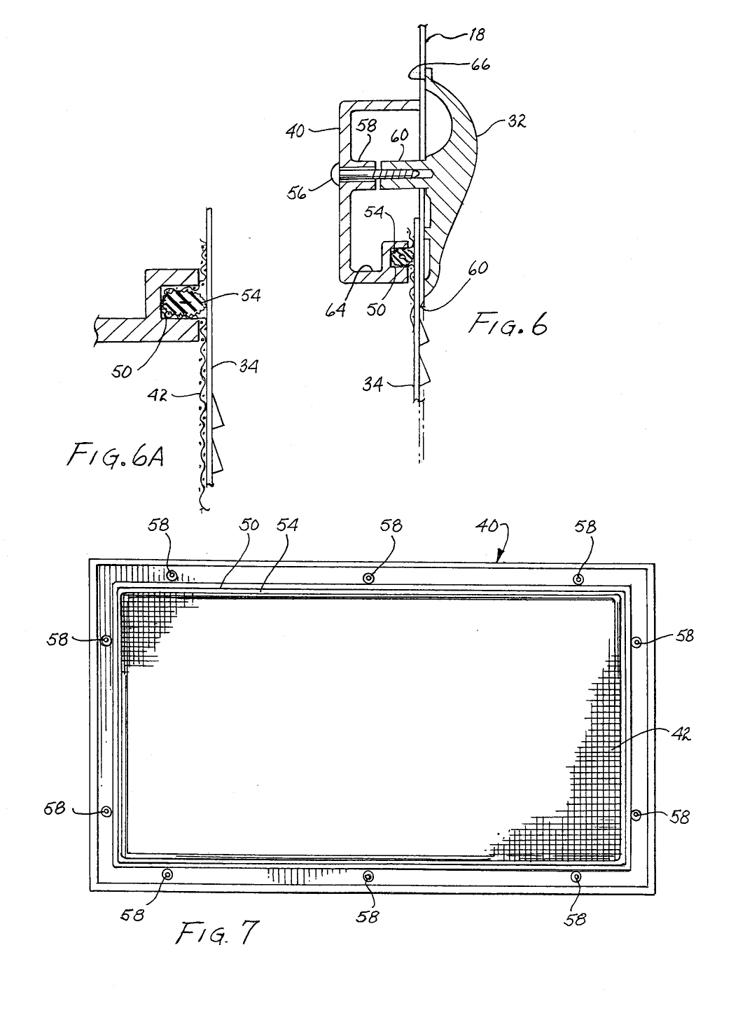

Referring jointly to FIGS. 6 and 6A, there are shown details of the screen retention mechanism and the juxtaposed louvered panel. In particular, groove 50 is formed as part of interior surface 64 of interior frame 40. After laying screen 42 across the opening of interior frame 40 with the edges of the screen extending past groove 50 on all four sides, spline 54 is inserted into the groove to retain the screen within the groove, as particularly shown in FIG. 6A. The conventional use of splines to retain a screen or mesh in a groove requires the use of a lip or the like extending into the groove to provide a restriction against extraction of the spline. In the present invention, such a lip or retaining member is unnecessary because louvered panel 34 bears directly against the spline at the opening to groove 50 and prevents extraction or displacement of the spline from within the groove. Thus, the expenses attendant molding an interior frame with a lip within a groove or other retaining element is completely precluded and avoided.

FIG. 7 is a view of interior frame 40 having insect screen 42 secured within groove 50 by spline 54. Additionally, a plurality of bosses 58 are illustrated to provide a mechanical connection to the exterior frame with screws 56 extending through bosses 58 into threaded engagement with corresponding bosses 60 extending from the exterior frame, as described above.

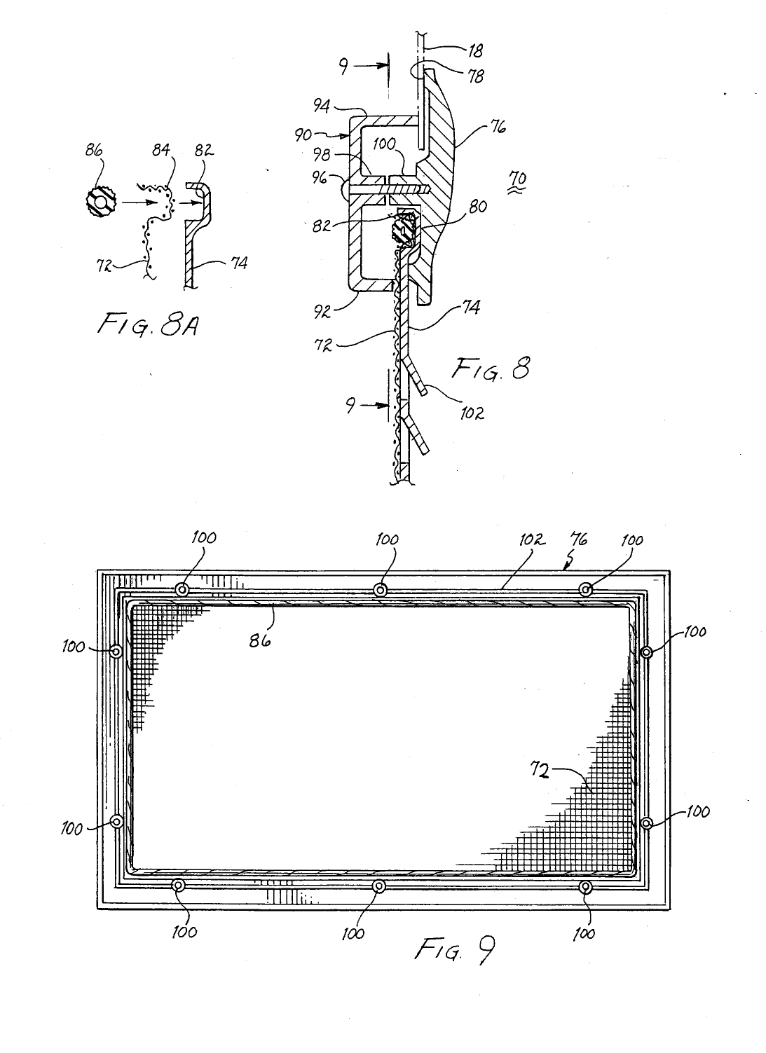

FIG. 8 illustrates a variant 70 of the apparatus for securing an insect screen 72 adjacent a louvered panel 74. An exterior frame 76 includes a peripheral edge 78 that bears against panel 18 of the garage door. The exterior frame includes an indentation or channel 80 extending along four sides of the exterior frame. Louvered panel 74 includes a trough 82, as particularly shown in FIG. 8A, that is supported within channel 80.

To secure insect screen 72 with louvered panel 74, an edge section 84 of the screen is placed over trough 82 and forced into the trough by a length of spline 86. By selecting a spline of a certain diameter relative to the trough, there will be frictional engagement between the spline, edge section 84 and the trough sufficient to prevent the spline from disengaging with the edge section.

Louvered panel 74 is secured to and retained against exterior frame 76 by an interior frame 90. As particularly illustrated in FIG. 8, interior frame 90 includes a leg 92 bearing against screen 72 and louvered panel 74 to force the louvered panel against exterior frame 76. A further wall 94 bears against the inside surface of channel 18 of the garage door. The interior frame is attached to the exterior frame by screws 96, or the like, extending through bosses 98 of the interior frame, and into threaded engagement with bosses 100 of the exterior frame. Because screen 72 is forced against louvered panel 74 and retained in place by wall 92 of the interior frame, there will exist no external forces, such as wind blowing through louvers 102 of the louvered panel, that otherwise might exert a force against screen 72 sufficient to withdraw the screen and spline from within trough 82.

FIG. 9 illustrates a rear view of variant 70 without interior frame 90 being attached to the exterior frame. In particular, a number of bosses 100 are illustrated disposed along the four sides of the exterior frame. Screen 70 is illustrated along with spline 86 disposed adjacent the perimeter of the screen to retain the screen in place, as described above. It may be noted that a wall 102 may extend between bosses 100 for purposes of rigidity and to assist in installation of louvered panel 74 with attached screen 72.

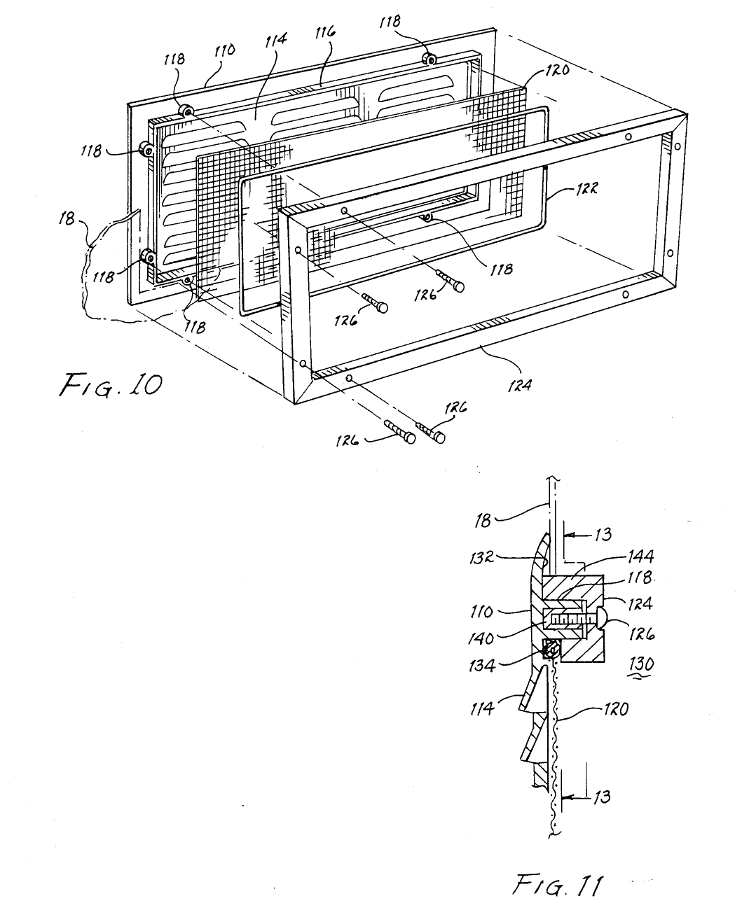

FIG. 10 is an exploded view illustrating the components attendant a yet further variant of the apparatus for retaining an insect screen adjacent a louvered panel. In particular, it includes an exterior frame 110 located adjacent the outer surface of a garage door panel 18 (partly shown). A louvered panel 114 is formed as a part of and circumscribed by exterior frame 110. A perimeter wall 116 provides robustness to the exterior frame/louvered panel and structural strength to a plurality of bosses 118. An insect screen 120 is retained adjacent louvered panel 114 by a spline 122. An interior frame 124 secures the spline adjacent the insect screen to maintain it in place. It is also attached to exterior frame 110 to maintain the components in place in door panel 18. As illustrated, a plurality of screws/bolts 126 extended through interior frame 124 into threaded engagement with bosses 118 of exterior frame 110.

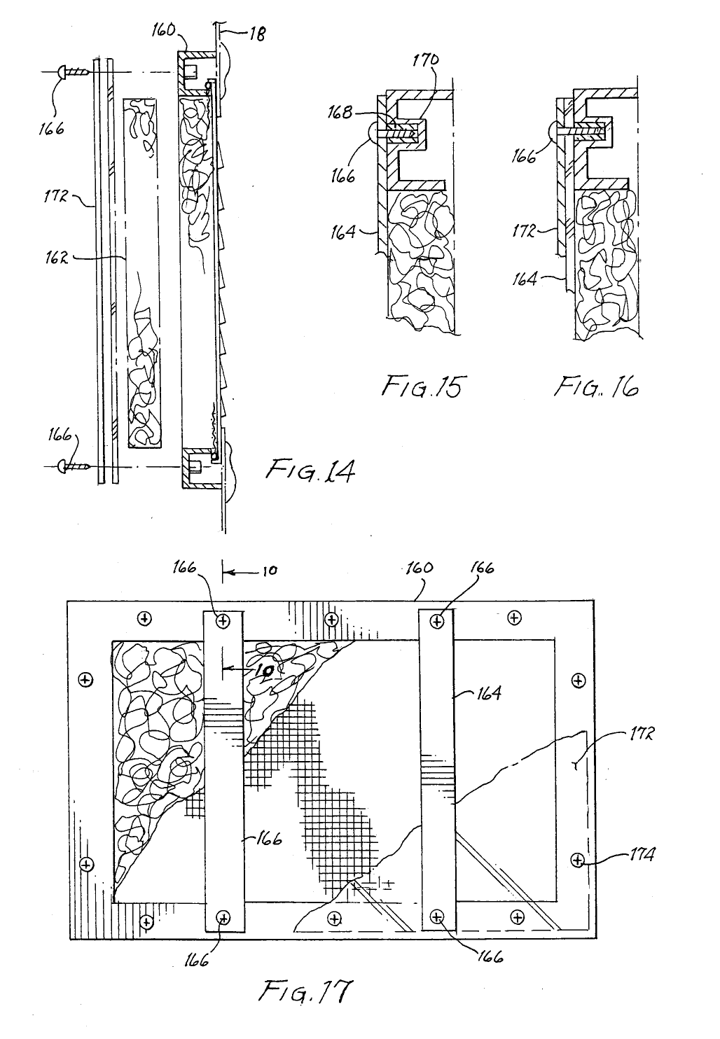

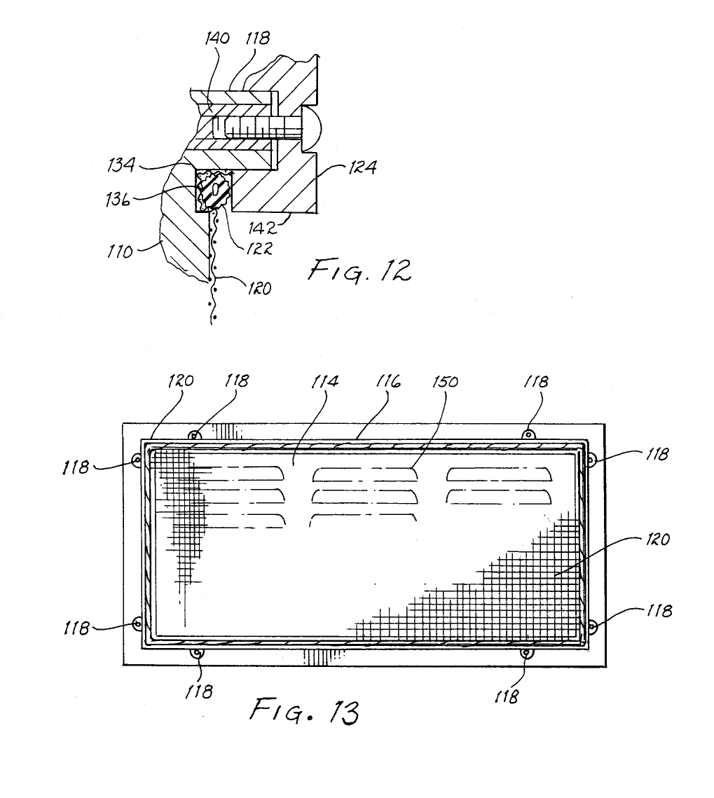

Referring joint to FIGS. 11 and 12, there is shown a further variant 130 for securing insect screen 120 to louvered panel 114. Exterior frame 110 is attached to or is formed a part of louvered panel 114. A peripheral edge 132 of the exterior frame bears against the exterior surface of door panel 18. A trough 134 extends along exterior frame 110 laterally of louvered panel 114. As particularly shown in FIG. 12, insect screen 120 includes an edge section 136 placed within trough 134. A spline 120 is pressed against the edge section to force it into trough 136 and by appropriate dimensioning of the spline it will be frictionally retained within the trough and thereby secure the edge section of the insect screen therein.

Each of bosses 118 extending inwardly from exterior frame 110 may include a threaded metallic insert 140. Interior frame 124 includes a wall 142 located to bear against spline 122 to firmly retain the spline and the underlying edge of section of the insect screen within trough 134. A further wall 144 of interior frame 124 bears against the interior surface of panel 18.

Screws on bolt 126 permanently engage interior frame 124 by threaded engagement with inserts 140 in bosses 118 of the exterior frame. Upon tightening the bolts, wall 144 bears against one side of door panel 18 and peripheral edge 132 of the exterior frame bears against the other side of the door panel. Thereby, variant 130 is retained in place within the opening in the door panel.

FIG. 13 is a rear elevational view of the insect screen attached to the exterior frame and the louvered panel formed with it. In particular, FIG. 13 illustrates screen 120 extending across the openings represented by louvers 150 and louvered panel 114 to prevent intrusion of insects and other foreign matter. Moreover, it illustrates spline 120 bearing against the insect screen to retain it in place.

Referring jointly to FIGS. 14, 15, 16, and 17, there is shown further structures that may be incorporated to provide thermal insulation for locations where cold weather exists. Additionally, attachment of an impervious plate may be employed to prevent any air flow through the vent. For illustrative purposes, the apparatus for securing the insect screen adjacent the louvered panel are shown generically rather than one of the embodiments, particularly illustrated in FIG. 6, 8 or 11.

The interior space defined by interior frame 160 may be filled with a sheet 162 of thermal insulation material. The sheet may be retained in place by straps 164, 166 attached to opposed sides of interior frame 160 by screws or bolts 166 permanently engaging metallic inserts 168 disposed within bosses 170. Alternatively, or in addition to use of insulation material, a plate may be secured to interior frame 160. This plate may be secured in place by straps 164, as illustrated in FIGS. 14, 16 and 17, or the plate may be secured directly to interior frame 160 by screws or bolts 174, as illustrated in FIG. 17. Moreover, the plates may be transparent, as depicted in FIG. 17, translucent or opaque. It is to be understood that the primary purpose of plate 172 is that of sealing the interior opening of the vent to prevent airflow there, through primarily during periods of very cold weather.

I claim:

1. A louvered vent, said vent comprising in combination:
a) an interior frame defining an opening;
b) a groove disposed in said frame and extending about the opening;
c) a flexible screen adapted to extend across the opening and into said groove;
d) a spline for securing said screen in said groove;
e) a louvered panel extending across the opening and said groove for retaining said spline in said groove; and
f) an exterior frame adapted for attachment to said interior frame to retain said louvered panel in place.

2. The vent as set forth in claim 1, including fastening means for engaging said interior frame with said exterior frame.

3. The vent as set forth in claim 2, wherein said fastening means comprises bolts.

4. The vent as set forth in claim 1, wherein said louvered vent is adapted for mounting within an opening in a panel of a garage door and wherein said exterior frame includes a peripheral edge for bearing against the exterior surface of the panel and wherein said interior frame is adapted to bear against the interior surface of the panel.

5. The vent as set forth in claim 1, including a sheet of thermal insulation material disposed within the boundary defined by said interior frame.

6. The vent as set forth in claim 5, including at least one strap secured to said interior frame for retaining said sheet in place.

7. The vent as set forth in claim 1, including a plate sized to generally correspond with the perimeter of said interior frame and attachment means for securing said plate with said interior frame.

8. The vent as set forth in claim 7, including a sheet of thermal insulation material disposed within the boundary defined by said interior frame.

9. A method for assembling a vent, said method comprising the steps of:
a) placing an insect screen across an opening defined by a first frame and across a groove disposed in the first frame;
b) forcing a spline into the groove to locate a juxtaposed edge section of the insect screen in the groove;
c) placing a louvered panel adjacent the insect screen and in overlapping relationship with the groove; and
d) attaching a second frame to the first frame to retain the louvered panel in place.

10. The method as set forth in claim 9, including the step of placing the first frame adjacent the interior surface of a panel of a garage door in juxtaposed relationship with an opening in the panel of the garage door, the step of locating the second frame adjacent the exterior surface of the panel of the garage door in juxtaposed relationship with the opening in the garage door and the step of securing the first frame with the second frame to retain the vent in the panel of the garage door.

11. The method as set forth in claim 9, including the step of locating a sheet of thermal insulation material within the boundary of the first frame.

12. The method as set forth in claim 9, including the step of maintaining a plate adjacent the first frame to restrain air flow through the vent.

13. A vent for an opening in a garage door, said vent comprising in combination:
a) a louvered panel generally dimensioned to correspond with the opening in the garage door;
b) an exterior frame extending from and surrounding said louvered panel;
c) a groove disposed in said exterior frame;
d) an insect screen extending across said louvered panel and having an edge section extending across said groove;
e) a spline adapted for urging said edge section into said groove; and
f) an interior frame for engagement with said exterior frame and for retaining said spline in said groove.

14. The vent as set forth in claim 13, wherein said louvered panel and said exterior frame comprise a unitary structure.

15. The vent as set forth in claim 13, wherein said interior frame includes a wall coincident with said groove.

16. The vent as set forth in claim 13, wherein said exterior frame includes a peripheral edge adapted to be place against the exterior surface of the garage door surrounding the opening and wherein said interior frame includes a wall adapted to be placed against the interior surface of the garage door surrounding the opening.

17. The vent as set forth in claim 16, including attachment means for securing said interior frame with said exterior frame.

18. The vent as set forth in claim 13, including attachment means for securing said interior frame with said exterior frame.

19. A vent for an opening in a garage door, said vent comprising in combination:
a) a louvered panel having a perimeter generally dimensioned to correspond with the opening in the garage door;
b) a trough disposed in said louvered panel and generally adjacent the perimeter of said louvered panel;
c) an insect screen extending adjacent said louvered panel and having an edge section extending across said trough;
d) a spline located adjacent the edge section to force said edge section into said trough and to retain said edge section in said trough;
e) an exterior frame having a peripheral edge extending laterally past the edge of the opening in the garage door for bearing against the garage door;
f) an interior frame having a first wall for bearing against said insect screen adjacent said louvered panel and a second wall for bearing against the garage door; and
g) attachment means for securing said interior frame with said exterior frame to retain said louvered panel generally coincident with the opening in the garage door.

20. A vent as set forth in claim 19, wherein said attachment means comprises bolts.

21. A method for assembling a vent with an insect screen, said method comprising the steps of:
a) placing the insect screen adjacent a louvered panel;
b) locating an edge section of the insect screen surrounding the insect screen in a groove;
c) inserting a spline in the groove to retain the edge section in the groove;
d) attaching an exterior frame with an interior frame to secure the louvered panel and the insect screen with the exterior and interior frames.

22. A method for assembling a vent with an insect screen, said method comprising in combination;
a) placing the insect screen adjacent a louvered panel;
b) locating an edge section of the insect screen surrounding the insect screen in a trough;
c) inserting a spline in the trough to retain the edge section in the trough;
d) attaching an exterior frame with an interior frame to secure the louvered panel and the insect screen with the exterior and interior frames.
